(19) United States
(12) Patent Application Publication
(10) Pub. No.: US 2015/0364030 A1
(43) Pub. Date: Dec. 17, 2015

(54) Emergency Alert Device

(71) Applicant: Timothy Comstock, Indian Rocks Beach, FL (US)

(72) Inventor: Timothy Comstock, Indian Rocks Beach, FL (US)

(21) Appl. No.: 14/742,357

(22) Filed: Jun. 17, 2015

Related U.S. Application Data
(60) Provisional application No. 62/013,045, filed on Jun. 17, 2014.

(51) Int. Cl. G08B 25/01; G08B 25/10

(52) U.S. Cl. CPC G08B 25/016; G08B 25/10

(57) ABSTRACT

An emergency alert device for providing a user with means for requesting emergency assistance. The emergency alert device includes a support device, such as a cane, walker, wheelchair, or the like, wherein the support device includes a control circuit therein. The control circuit includes a microprocessor, a wireless transmitter, and at least one control, wherein operation of the control causes the wireless transmitter to send a signal to a mobile electronic device paired with the support device. Upon receipt of the signal, the mobile electronic device is configured to send a message to one or more persons so as to request emergency assistance for the user. The support device may further include one or more sensors for monitoring physiological information, wherein said information is then displayed on the mobile electronic device.

### CROSS REFERENCE TO RELATED APPLICATION

This application claims the benefit of U.S. Provisional Application No. 62/013,045 filed on Jun. 17, 2014. The above identified patent application is herein incorporated by reference in its entirety to provide continuity of disclosure.

### BACKGROUND OF THE INVENTION

### Field of the Invention

The present invention relates to an emergency alert system. More specifically, the present invention provides a support device, such as a cane or walker, among others, that includes a system for alerting an emergency contact or emergency responders when the user requires assistance. A control circuit includes a control and a wireless transmitted adapted to send a signal to a mobile device, wherein the mobile device may then send a message or signal to the mobile device of an emergency contact or emergency responder.

Many people frequently require medical assistance as result of advanced age, a chronic health condition, a handicap, or the like. However, it can be difficult to reach out for assistance when the person is having a medical issue. The individual may not have convenient access to a telephone, or may be unable to reach the telephone. Further, many people live alone and have no one to help them during an emergency situation and it is imperative that the person is able to obtain assistance during an emergency event.

Devices have been disclosed in the prior art that relate to XXX. These include devices that have been patented and published in patent application publications. These devices generally relate to walking aids having digital monitoring devices or sensors, such as U.S. Published Patent Application Number 2007/0000531, U.S. Published Patent Application Number 2011/0023920, U.S. Pat. No. 6,745,786, U.S. Pat. No. 8,670,953, and U.S. Pat. No. 5,799,258.

These prior art devices have several known drawbacks. The devices in the prior art provide walking aids that help to monitor the user's physiological information, but do not include an emergency alert system that allows the user to obtain assistance during an emergency situation. The prior art devices do not include a walking aid that wirelessly communicates with a cell phone so as to allow the user to obtain emergency assistance.

In light of the devices disclosed in the prior art, it is submitted that the present invention substantially diverges in design elements from the prior art and consequently it is clear that there is a need in the art for an improvement to existing emergency alert devices. In this regard the instant invention substantially fulfills these needs.

### SUMMARY OF THE INVENTION

In view of the foregoing disadvantages inherent in the known types of emergency alert devices now present in the prior art, the present invention provides a new support device having an emergency alert system wherein the same can be utilized for providing convenience for the user when obtaining assistance in an emergency situation.

It is therefore an object of the present invention to provide a new and improved emergency alert device comprising a support device having a control circuit that is adapted to allow a user to send a mobile device a signal when the user requires emergency assistance.

It is another object of the present invention to provide an emergency alert device wherein the support device comprises a cane, walker, wheelchair, or other similar device.

Another object of the present invention is to provide an emergency alert device comprising a control circuit having a control that a user can operate to transmit a signal in order to obtain emergency assistance.

Yet another object of the present invention is to provide an emergency alert device adapted to transmit a signal to a user's mobile device, wherein the mobile device can then send a message to the user's emergency contacts or emergency responders in order to allow the user to obtain assistance.

A further object of the present invention is to provide an emergency alert device comprising sensors for measuring or monitoring the user's heartrate and temperature.

Another object of the present invention is to provide an emergency alert device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first embodiment of the support device resembling a cane.

FIG. 2 shows a perspective view of a second embodiment of the support device resembling a walker.

FIG. 3 shows a schematic diagram of the components of the emergency alert system.

FIG. 4 shows a flowchart of the operation of the emergency alert device of the present invention.

### DETAILED DESCRIPTION OF THE INVENTION

Reference is made herein to the attached drawings. Like reference numerals are used throughout the drawings to depict like or similar elements of the emergency alert device. For the purposes of presenting a brief and clear description of the present invention, the preferred embodiment will be discussed as used for XXX. The figures are intended for representative purposes only and should not be considered to be limiting in any respect.

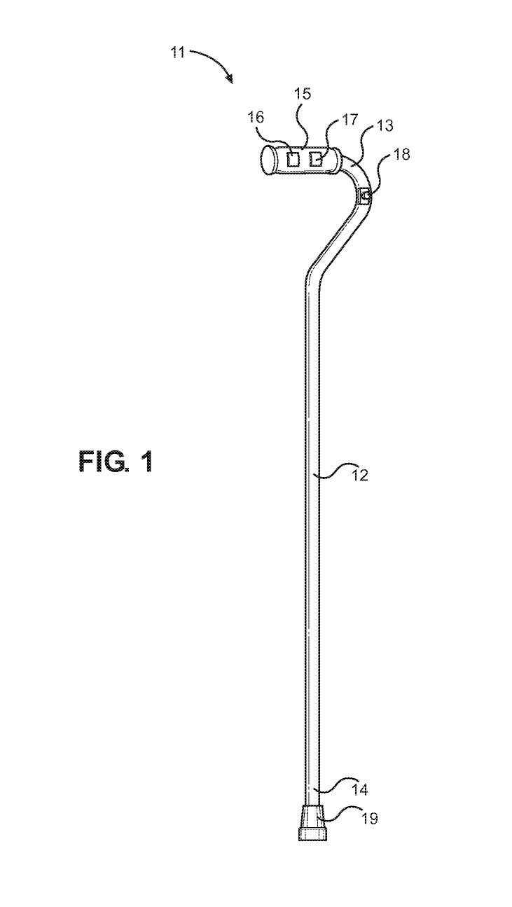

Referring now to FIG. 1, there is shown a perspective view of a first embodiment of the support device resembling a cane. The support device 11 is used to help the user to balance while standing, walking, or otherwise moving about. Thus, the support device 11 may be constructed as any type of walking aid, such as walkers, canes, and wheelchairs, among others, depending upon the embodiment. In the illustrated embodiment, the support device 11 comprises a cane 12 having an upper end 13 and a lower end 12. The cane 12 comprises an elongated portion and includes a foot 19 on the lower end 14 thereof, wherein the foot 19 is adapted to contact the ground. The foot 19 is preferably composed of a high-friction material, such as rubber, so that the foot 19 does not slip on the ground.

The upper end 13 of the cane 12 comprises a handle 15. The handle 15 may include padding or cushioning thereon so as to improve the user's grip and so as to improve the user's comfort. The handle 15 includes one or more sensors thereon. In the illustrated embodiment, the handle 15 includes a first sensor 16 adapted to determine the user's body temperature. A second sensor 17 is provided, wherein the second sensor 17 is used to determine the user's heartrate. The first and second sensors 16, 17 are electrically connected to a microprocessor and to a transmitter, wherein the transmitter is adapted to transmit the data collected by the first and second sensors 16, 17 to a mobile electronic device, such as a cell phone. In this way, the user can track their temperature and heartrate using their mobile devices. A software application may be provided, wherein the software application allows a user to view the physiological information collected via the sensors.

The support device 11 further comprises an emergency alert system comprising a control circuit housed therein. The control circuit comprises a control 18, a microprocessor, a wireless transmitter, and one or more sensors as described above. The control 18 preferably includes a push-button that can be depressed by the user in order to transmit a signal from the support device 11 to a mobile device that is paired with the support device 11. The user may pair the support device 11 with his or her mobile electronic device, such as a cell phone, in order to allow the support device 11 to transmit signals and data thereto.

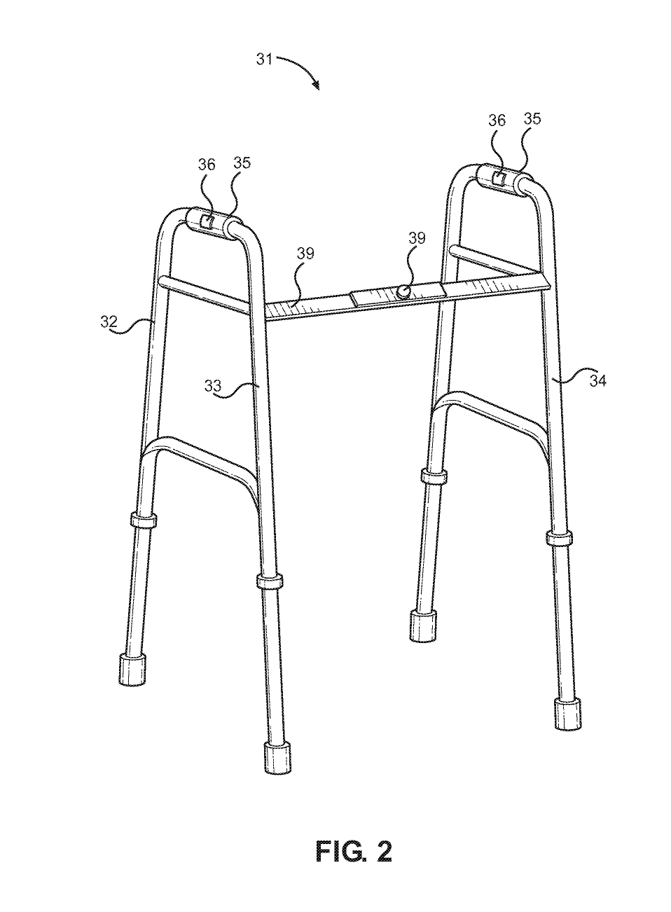

Referring now to FIG. 2, there is shown a perspective view of a second embodiment of the support device resembling a walker. In the illustrated embodiment, the support device 31 comprises a walker. The walker includes a frame 32 having a first section 33 and a second section 34, wherein the first and second section 33, 34 are connected via a crossbar 39. The first section 33 and second section 34 are preferably parallel to one another and are of substantially the same construction.

The upper end of each of the first and second sections 33, 34 comprise handles 35 thereon. The handles 35 may include cushioning or padding thereon to allow the user to more easily grip the same. The handles 35 further include one or more sensors for monitoring the user's vital signs and other physiological information. In the illustrated embodiment, the handles 35 include a first sensor 36 for monitoring a user's heartrate, and a second sensor 37 for monitoring the user's body temperature.

The illustrated embodiment further includes a control circuit adapted to transmit a signal from the support device to a mobile electronic device. The control circuit includes a control 38 that can be operated by the user in order to transmit a signal for the user to obtain assistance from the user's emergency contacts. Thus, the illustrated embodiment includes the same emergency alert system as the embodiment shown in FIG. 1 and differs only in the form of the support device 31.

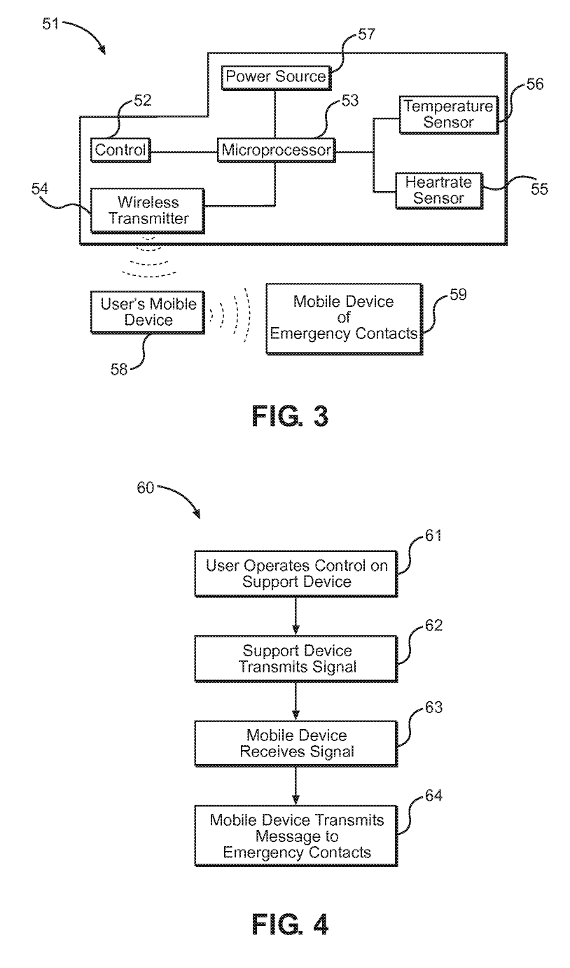

Referring now to FIG. 3, there is shown a schematic diagram of the components of the emergency alert system. The support device encloses an emergency alert system 51 having a control circuit. The control circuit includes a microprocessor 53, a power source 57, a wireless transmitter 54, a control 52, and one or more sensors 55, 56. The emergency alert system allows a user to transmit a signal from the support device so that the user can obtain assistance in the event of an emergency.

The support device 11 is adapted to be used in conjunction with a mobile electronic device, such as a cell phone or other similar device. The mobile electronic device can be paired with the support device so that the mobile electronic device is able to receive the signal transmitted by the support device. A software application may be provided for allowing the mobile electronic device to receive the signal transmitted by the support device.

The software application further allows the user to input a list of emergency contacts. The emergency contacts include the contact's name, relationship to the user, and phone number. The emergency contacts preferably include members of the user's family, caretaker, and/or a healthcare provider. The user can update or edit the list of emergency contacts using the software application on the mobile device.

Referring now to FIG. 4, there is shown a flowchart of the operation of the emergency alert device of the present invention. In operation, the user can utilize the emergency alert system 60 in order to easily contact emergency contacts in order to obtain assistance in an emergency situation. When the user requires assistance, the user can operate the control on the support device 61. Operating the control causes the support device to transmit a signal 62 to the mobile device paired with the support device. The mobile device receives the signal 63 from the support device. Once the signal is received, the mobile device is adapted to send a message to the emergency contacts listed by the user 64. The message is preferably a predetermined messaged that notifies the emergency contacts that the user requires assistance. In this way, the user can easily reach out to multiple people by pressing a single button, and allows the user to be able to obtain assistance at any time.

In some embodiments, the emergency alert system further comprises a gyroscope for detecting the position of the support device 11. If the gyroscope detects that the support device 11 is in a horizontal position, indicating that the user has fallen or collapsed, the support device 11 automatically transmits a signal to the mobile electronic device that is paired to the support device. In this way, if the user loses consciousness and is unable to operate the control, the positioning of the support device 11 will cause the emergency alert device to transmit a signal so that the user can obtain help. Preferably, the support device 11 requires that the support device 11 be in a horizontal position for a predetermined amount of time prior to sending a signal so as to prevent signals from being sent when the support device 11 has simply tipped over accidentally.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An emergency alert device, comprising:
a support device for assisting a user's movement;
a control circuit enclosed within said support device, wherein said control circuit comprises a microprocessor, a wireless transmitter, and at least one control;
wherein said wireless transmitter is adapted to send a signal to a mobile electronic device when said at least one control is actuated.

2) The emergency alert device of claim 1, wherein said support device comprises a cane.

3) The emergency alert device of claim 2, wherein said cane comprises an upper end and a lower end, wherein said upper end comprises a handle having one or more sensors thereon.

4) The emergency alert device of claim 3, wherein said one or more sensors comprises a temperature sensor operably connected to said control circuit.

5) The emergency alert device of claim 3, wherein said one or more sensors comprises a heartrate monitoring device operably connected to said control circuit.

6) The emergency alert device of claim 1, wherein said support device comprises a walker.

7) The emergency alert device of claim 6, wherein said walker comprises an upper end and a lower end, wherein said upper end comprises a pair of handles thereon, said pair of handles having one or more sensors thereon.

8) The emergency alert device of claim 7, wherein said one or more sensors comprise a heartrate monitoring device operably connected to said control circuit.

9) The emergency alert device of claim 7, wherein said one or more sensors comprise a temperature sensor operably connected to said control circuit.

10) The emergency alert device of claim 1, wherein said control circuit further comprises one or more

[symbol]

11) The emergency alert device of claim 1, wherein said mobile electronic device is adapted to send a second mobile electronic device a message when said mobile electronic device receives a signal from said support device.

12) The emergency alert device of claim 1, wherein said mobile electronic device is in wireless communication with said support device.
